(19) United States
(12) Patent Application Publication
(10) Pub. No.: US 2013/0110642 A1
(43) Pub. Date: May 2, 2013

(54) METHOD AND APPARATUS FOR PROVIDING PERSONALIZED ADVERTISEMENTS

(71) Applicants: Wei Yeh Lee, New York, NY (US); Sergey Boldyrev, Soderkulla (FI); Ian Justin Oliver, Soderkkulla (FI)

(72) Inventors: Wei Yeh Lee, New York, NY (US); Sergey Boldyrev, Soderkulla (FI); Ian Justin Oliver, Soderkkulla (FI)

(21) Appl. No.: 13/538,180

(22) Filed: Jun. 29, 2012

Related U.S. Application Data
(60) Provisional application No. 61/503,197, filed on Jun. 30, 2011.

(51) Int. Cl. G06Q 30/02

(52) U.S. Cl. CPC G06Q 30/0271
USPC 705/14.67

(57) ABSTRACT

An approach is provided for providing personalized advertisements. A personalization platform determines, at one or more user devices, context information, user profile information, or a combination thereof from one or more information sources associated with one or more users of the one or more user devices, the one or more user devices, or a combination thereof. The personalization platform further processes and/or facilitates a processing of the context information, the user profile information, or a combination to cause, at least in part, a generation of one or more requests for advertising information. The personalization platform also causes, at least in part, a transmission of the one or more requests to at least one advertising engine.

### RELATED APPLICATIONS

This application claims benefit of the earlier filing date under 35 U.S.C. §119(e) of U.S. Provisional Application Ser. No. 61/503,197 field Jun. 30, 2011, entitled “Method and Apparatus for Providing Personalized Advertisements,” the entirety of which is incorporated herein by reference.

### BACKGROUND

Service providers and device manufacturers (e.g., wireless, cellular, etc.) are continually challenged to deliver value and convenience to consumers by, for example, providing compelling network services. These network services may generate revenue from the network services by presenting advertisements to users of the services. Examples of network services include messaging services, maps and navigation services, social networking services, media services, purchasing services, gaming services, and the like. Advertisements can be positioned in the same screen as an active service presented to a user and/or as in a separate view before, after, or during the use of the service. Typically an advertiser will agree with an ad network to initiate an advertisement campaign. The campaign may be initiated through an automated system such as a self serve interface to an advertisement server, or by meeting and signing a contract. The advertisement campaign may include a number of parameters such as an impression target, number of unique user to be reached, frequency capping, etc. An advertising campaign may be made of different advertising flights each having possibly different validity times and targeted publishers or users. In order to increase effectiveness of advertisements, device manufacturers and service providers tailor the advertisements to the needs and/or interests of consumers, by collecting personal information such as personal profiles, search history, sites visited, etc. related to the consumers. For example, when a user visits a webpage of a vendor, information regarding the user's habits, preferences, purchase history, demographics, contact information and other personal data is maintained at the discretion of the vendor. In exchange for this level of access to the user's information, the vendor offers the user various incentives such as prizes, points and discounts. Unfortunately, the user cannot themselves mandate the terms regarding the type of personal information they are willing to share with different vendors and the type of advertisements they are willing to receive in return. Instead, the users are bound to receive advertisements selected by service providers.

### SOME EXAMPLE EMBODIMENTS

Therefore, there is a need for an approach for providing personalized advertisements based on user preferences.

According to one embodiment, a method comprises determining, at one or more user devices, context information, user profile information, or a combination thereof from one or more information sources associated with one or more users of the one or more user devices, the one or more user devices, or a combination thereof. The method also comprises processing and/or facilitating a processing of the context information, the user profile information, or a combination to cause, at least in part, a generation of one or more requests for advertising information. The method further comprises causing, at least in part, a transmission of the one or more requests to at least one advertising engine.

According to another embodiment, an apparatus comprises at least one processor, and at least one memory including computer program code for one or more computer programs, the at least one memory and the computer program code configured to, with the at least one processor, cause, at least in part, the apparatus to determine, at one or more user devices, context information, user profile information, or a combination thereof from one or more information sources associated with one or more users of the one or more user devices, the one or more user devices, or a combination thereof. The apparatus is also caused to process and/or facilitate a processing of the context information, the user profile information, or a combination to cause, at least in part, a generation of one or more requests for advertising information. The apparatus is further caused to cause, at least in part, a transmission of the one or more requests to at least one advertising engine.

According to another embodiment, a computer-readable storage medium carries one or more sequences of one or more instructions which, when executed by one or more processors, cause, at least in part, an apparatus to determine, at one or more user devices, context information, user profile information, or a combination thereof from one or more information sources associated with one or more users of the one or more user devices, the one or more user devices, or a combination thereof. The apparatus is also caused to process and/or facilitate a processing of the context information, the user profile information, or a combination to cause, at least in part, a generation of one or more requests for advertising information. The apparatus is further caused to cause, at least in part, a transmission of the one or more requests to at least one advertising engine.

According to another embodiment, an apparatus comprises means for determining, at one or more user devices, context information, user profile information, or a combination thereof from one or more information sources associated with one or more users of the one or more user devices, the one or more user devices, or a combination thereof. The apparatus also comprises means for processing and/or facilitating a processing of the context information, the user profile information, or a combination to cause, at least in part, a generation of one or more requests for advertising information. The apparatus further comprises means for causing, at least in part, a transmission of the one or more requests to at least one advertising engine.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing personalized advertisements, according to one embodiment;

FIG. 2 is a diagram of the components of a personalization platform, according to one embodiment;

FIG. 3 is a flowchart of a process for providing personalized advertisements, according to one embodiment;

FIGS. 4A-4E are diagrams of user interfaces representing various functional flows for enabling the control and sharing of user profile information, according to various embodiments;

FIG. 5 is a diagram of a personal cloud, according to one embodiment;

FIG. 6 is a diagram of anonymous personal usage tracking and synchronization in cloud, according to one embodiment;

FIGS. 7A-7B are diagrams of computation distribution among devices, according to various embodiments;

FIG. 8 is a diagram showing a process as a combination of primitive computation closures, according to one embodiment;

FIG. 9 is a diagram of process distribution from a device to another device, according to one embodiment; and

FIG. 10 is a diagram of computation closure allocation/mapping, according to one embodiment;

FIG. 11 is a diagram of hardware that can be used to implement an embodiment of the invention;

FIG. 12 is a diagram of a chip set that can be used to implement an embodiment of the invention; and

FIG. 13 is a diagram of a mobile terminal (e.g., handset) that can be used to implement an embodiment of the invention.

### DESCRIPTION OF SOME EMBODIMENTS

Examples of a method, apparatus, and computer program for providing personalized advertisements are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As will be discussed, a computation closure may include, for example, a particular computation procedure together with relations and communications among various processes including passing arguments, sharing process results, selecting results provided from computation of alternative inputs, flow of data and process results, etc. The computation closures (e.g., a granular reflective set of instructions, data, and/or related execution context or state) provide the capability of slicing of computations for processes and transmitting the computation slices between devices, infrastructures and information sources.

A cloud or information space may include, for example, an aggregated set of information and computation closures from different sources. This multi-sourcing is very flexible since it accounts and relies on the observation that the same piece of information or computation can come from different sources. Furthermore, multi-sourcing is well suited for enabling the sharing and exchange of information or computations within a distributed environment. In one embodiment, information and computations within the cloud are represented using Semantic Web standards such as Resource Description Framework (RDF), RDF Schema (RDFS), OWL (Web Ontology Language), FOAF (Friend of a Friend ontology), rule sets in RuleML (Rule Markup Language), etc. Furthermore, as used herein, RDF refers to a family of World Wide Web Consortium (W3C) specifications originally designed as a metadata data model. It has come to be used as a general method for conceptual description or modeling of information and computations that is implemented in web resources; using a variety of syntax formats. Although various embodiments are described with respect to clouds, it is contemplated that the approach described herein may be used with other structures and conceptual description methods used to create distributed models of information and computations.

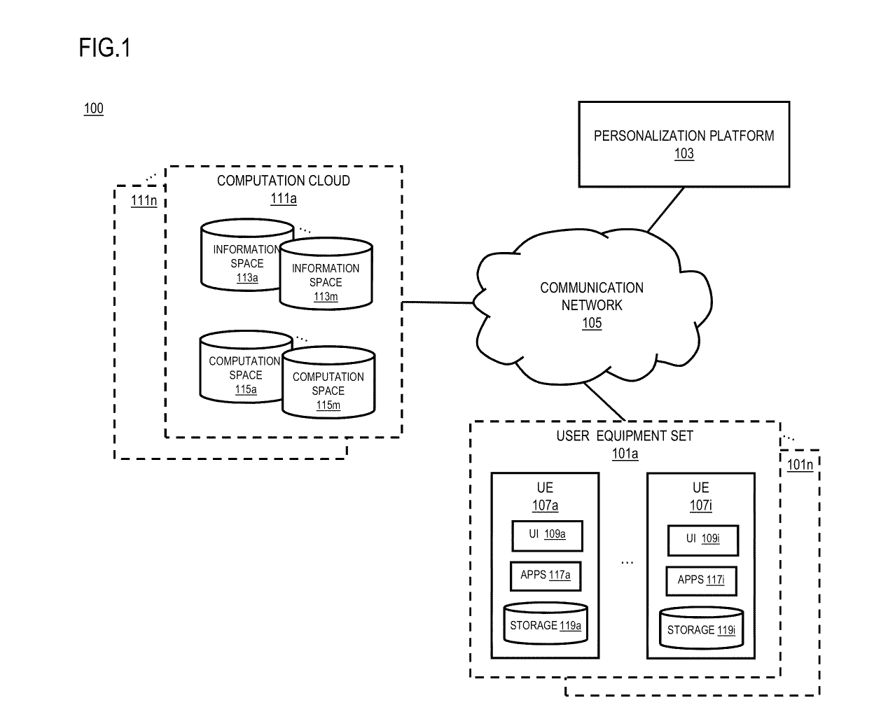

FIG. 1 is a diagram of a system capable of providing personalized advertisements, according to one embodiment. As previously described, a cloud environment consists of information and computation resources each consisting of several distributed devices that communicate information and computation closures (e.g. RDF graphs) via a shared memory. A device within a cloud environment, such as by virtue of a login and network access process, may store computation closures locally in its own memory space or publish computation closures on a globally accessible environment within the cloud. In the first case, the device is responsible for any process needed for combination or extraction of computations, while in the second case the processes can be conducted by the globally accessible environment which includes the device. The device can utilize the resources of the architectural infrastructure level, for example for energy saving, without having to access the cloud level, if energy cost is lower at the infrastructure level. Alternatively, a device may have direct computational closure connectors to the cloud level, where devices are more tightly linked to the cloud environment for energy saving purposes.

The basic concept of cloud computing technology provides access to distributed computations for various devices within the scope of the cloud, in such a way that the distributed nature of the computations is hidden from users and it appears to a user as if all the computations are performed on the same device. The cloud computing also enables a user to have control over computation distribution by transferring computations between devices that the user has access to. For example, a user may want to transfer computations among work devices, home devices, and portable devices, other private and public devices, etc. Current technologies enable a user of a mobile device to manipulate contexts such as data and information via the elements of a user interface of their user equipment. However, distribution of computations and processes related to or acting on the data and information within the cloud is typically controlled by the system. In other words, a cloud in general does not provide a user (e.g., an owner of a collection of information distributed over the information space) with the ability to control distribution of related computations and processes of, for instance, applications acting on the information. For example, a contact management application that processes contact information distributed within one or more clouds generally executes on a single device (e.g., with all processes and computations of the application also executing on the same device) to operate on the distributed information. In some cases (e.g., when computations are complex, the data set is large, etc.), providing a means to also distribute the related computations in addition to the information is advantageous.

This goal is achieved by introduction of the capability to construct, distribute, and aggregate computations as well as their related data. More specifically, to enable a user of a cloud (e.g., a mobile device user, an application developer, etc.) who connects to the cloud via one or more devices, to distribute computations among the one or more user devices or other devices with access to the cloud, each computation is deconstructed to its basic or primitive processes or computation closures. Once a computation is divided into its primitive computation closures, the processes within or represented by each closure may be executed in a distributed fashion and the processing results can be collected and aggregated into the result of the execution of the initial overall computation.

In one embodiment, cloud computing enables users to interact with other devices and execute one or more information and computation closures within the boundaries of the cloud. Within the cloud, devices may interact based on locally defined semantics that set the basis for their interaction within the computation clouds 111a-111n. Conventional means of accessing information, however, is limited given that the semantics and associated access privileges are established by others. For example, users have little to no control over how much personal information is gathered about them as they navigate a vendor's website to explore product offerings, consider purchases, update their preferences, etc. Furthermore, because the semantics of the engagement is set by the vendor, user's have little ability to control how information is shared by the vendor with others (e.g., affiliates), how they'd like product offerings to be presented to them as they navigate the site, terms and conditions favorable to them as they explore, etc.

In one embodiment, based on user interactions with a UE 107a-107i, relevant data that can be used to generate consumer preferences, profile, selections, etc. can be stored in local storage 119a-119i, transmitted to a computation cloud 111a-111n, wherein each cloud 111a-111n consists of information spaces 113a-113m and computation spaces 115a-115m, or a combination thereof.

In one embodiment, the user/device specific data on UE 107a-107i can be distributed to the cloud 111a-111n, at the time of connection; it can be mined, for example, from the information spaces 113a-113m, for further use in advertisement personalization.

It is noted that consumers surfing the internet have little or no control over the profile information that is gathered about them on the internet. However, consumers may have access to mechanisms (for example, via one or more applications 117a-117i) for capturing and configuring their own behavioral data by building data structures conveniently referred to as Personal Profile Stronghold (PPS). An implementation of a PPS can be built on top of a cloud infrastructure and provide a personal cloud which consists of the collection of all consumer devices (assuming that the consumer owns more than one device) together running PPS endpoints. The personal cloud can provide an authenticated, cryptographically protected, and hosted PPS endpoint solely for that specific user.

In one embodiment, consumers can manage their groups, load contact information from other sources (e.g., Outlook, Gmail, Facebook, etc.), manage relationship groups, register all of their devices to receive data, manage data, create data resource packages, assign data resource packages to be cached on specific devices, share data resource packages with groups or individuals, etc. However, the consumers still need a simple method to determine what profile resources to share with whom.

On the other hand, in the advertising industry today, Advertisement Targeting Engines (ATEs) decide what advertisements are sent to consumers. These ATEs are tuned to serve the needs of publishers and advertisers. Therefore there is a need for consumers to be able to target advertisements to themselves based on their preferences, their advertisement targeting configuration, their profile information, etc.

To address this problem, a system 100 of FIG. 1 introduces the capability to provide personalized advertisements. In one embodiment, a personalization platform 103 provides a trusted application 117a-117i to a user that enables the user to control and influence what, when, where, why and how they see advertisements, based on their own specified advertisement targeting configuration, their profile information, psychographics, demographics, firmographics (e.g. organization characteristics), behavioral profiles, etc.

In one embodiment, each advertisement served through the personalization platform 103 will come with visual controls (icons) that allow the user to interact with the advertisements (e.g., save, thumbs down, thumbs up, flip to next advertisement, zap, comment on the advertisement, see random next advertisement, click the advertisement, etc). The user will also be able to choose to see a random advertisement for the desired level of value in return (e.g., monetization, discounts, free products, etc).

In one embodiment, the personalization platform 103 has a configuration table integrated into the PPS structure, so the consumer can configure the personalization platform to help train and control the behavior of the advertisements served. In the configuration table, the consumer can manage the overall default configuration to, for example, not receiving advertisements and paying for the content, receiving self-targeted advertisements to pay for content and monetizing the remainder, not using the services provided by the personalization platform, etc.

In one embodiment, the consumer can manage these settings on a URL by URL basis as desired. All the basic consumer visibility settings that apply with the base PPS (anonymous, pseudonymous, and fully-disclosed) may apply to all configurations.

In one embodiment, the personalization platform 103 may act as the consumer's agent and can execute a personal advertisement search (e.g., by proxy or directly). The personalization platform 103 executes a personal advertisement search by looking at the consumer's private profile (instantaneous context, geographic, demographic, firmographic, psychographic, behavioral, etc) and decides which keywords to use in the advertisement search request based on the person's private profile. After formulating the request, the advertisement search request is sent to an advertisement search engine either directly or via a proxy with the appropriate consumer visibility settings (anonymous, pseudonymous, fully-disclosed, etc.).

In one embodiment, personal data can be collected in various ways such as, for example, communication logging (HTTP, Email, SMS, IM, Skype, etc.), device sensor logging (activity, GPS, photos, audio, etc.), personal data entry (forms entry, contextual data entry, etc.), personal profile data extraction (demographic, firmographic, behavioral, etc.), etc., wherein each collection mechanism is an functional flow that can constitute PPS.

In one embodiment, consumers have control over each of these collection mechanisms by choosing to invoke a certain functional flow or not. If the consumer chose to invoke collection mechanism through a certain functional flow, then there will be a simple End User License Agreement (EULA) that defines exactly what data they are collecting.

In one embodiment, from a simplicity perspective, the consumer can choose, at a macro level, the collection template to use via a slider. (e.g., Minimal, Medium, Complete). The consumer can then select to use the functional flow configuration interface to further customize by enabling/disabling specific behavioral attributes from being collected.

As shown in FIG. 1, the system 100 comprises sets 101a-101n of user equipments (UEs) 107a-107i having connectivity to a personalization platform via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UEs 107a-107i are any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UEs 107a-107i can support any type of interface to the user (such as “wearable” circuitry, etc.).

By way of example, the UE 101, and the personalization platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

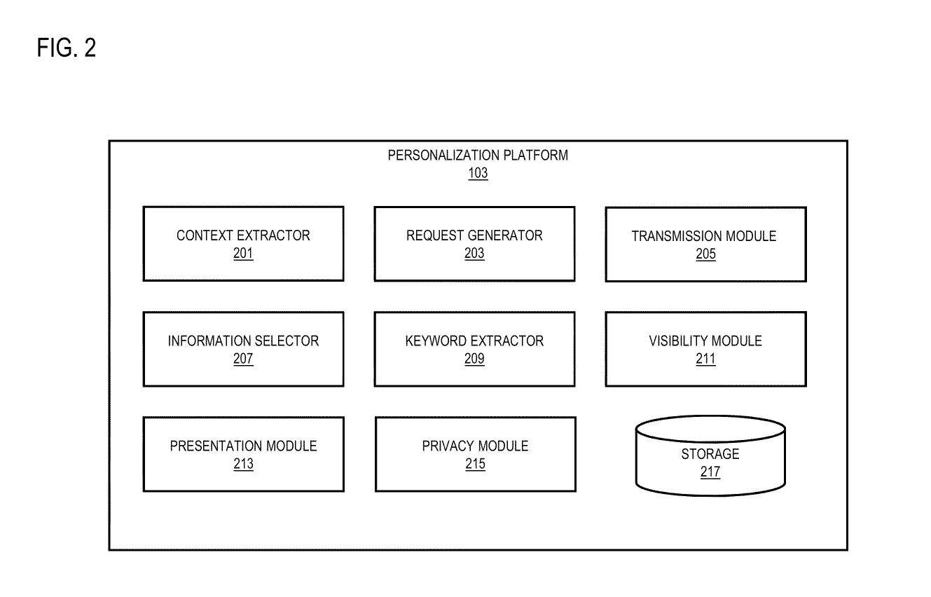

FIG. 2 is a diagram of the components of a personalization platform, according to one embodiment. By way of example, the personalization platform 103 includes one or more components for providing personalized advertisements. It is contemplated that the functions of these components may be combined in one or more components or performed by other components of equivalent functionality. In this embodiment, the personalization platform 103 includes a context extractor 201, a request generator 203, a transmission module 205, an information selector 207, a keyword extractor 209, a visibility module 211, a presentation module 213, a privacy module 215, and a storage 217.

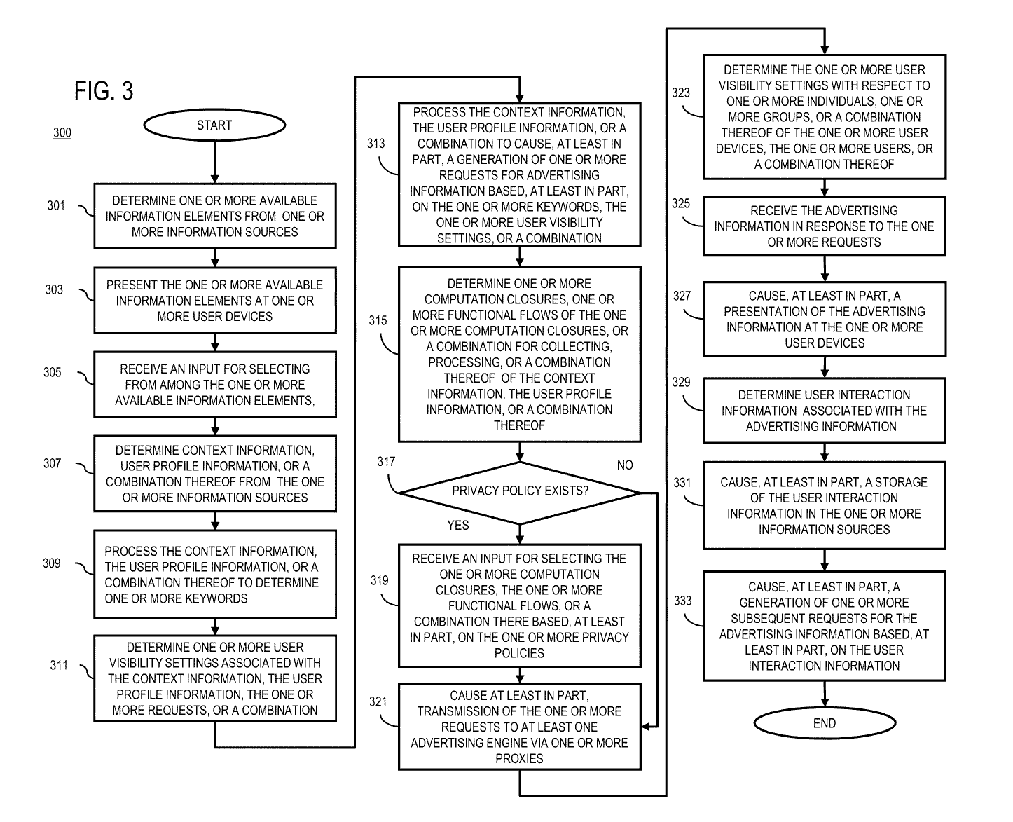

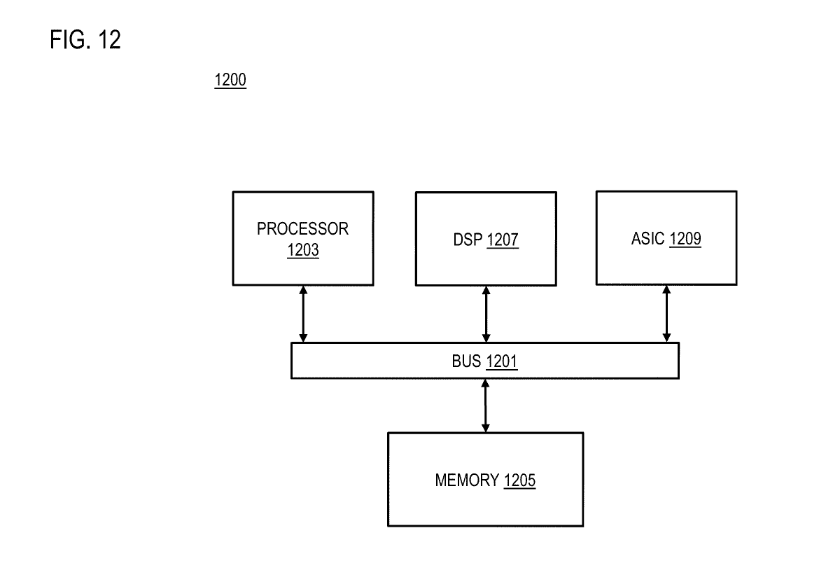

FIG. 2 is described with reference to FIG. 3, wherein FIG. 3 is a flowchart of a process for providing personalized advertisements, according to one embodiment. In one embodiment, the personalization platform 103 performs the process 300 and is implemented in, for instance, a chip set including a processor and a memory as shown in FIG. 12.

In one embodiment, in step 301 of process 300, the context extractor 201 determines one or more available information elements from one or more information sources such as, for example, information spaces 113a-113m, associated with one or more users of the one or more user devices 107a-107i, the one or more user devices 107a-107i, or a combination thereof. The determined available information elements may be stored in storage 217, in information spaces 113a-113m or a combination thereof, for further access.

In one embodiment, per step 303 of FIG. 3, the information selector 207 causes, at least in part, a presentation of the one or more available information elements at the one or more user devices 107a-107i. Subsequently, per step 305 of FIG. 3, the information selector 207 receives an input from the user of UE 107a-107i for selecting from among the one or more available information elements. The user input may be stored in storage 217, in information spaces 113a-113m, in storage 119a-119i, or a combination thereof, for further access.

In one embodiment, per step 307 of FIG. 3, the context extractor 201 determines, at one or more user devices 107a-107i, context information, user profile information, or a combination thereof from the one or more information sources such as, for example, information spaces 113a-113m, associated with one or more users of the one or more user devices 107a-107i, the one or more user devices 107a-107i, or a combination thereof. The context information, the user profile information, or a combination thereof may include, at least in part, the available information elements selected by the information selector 207. The extracted information may be stored in storage 217, in information spaces 113a-113m, in storage 119a-119i, or a combination thereof, for further access.

In one embodiment, the one or more available information elements, the context information, the user profile information, or a combination thereof may include, at least in part, advertisement targeting configuration information, demographic information, psychographic information, firmographic information, behavioral information, or a combination thereof.

In one embodiment, per step 309 of FIG. 3, the keyword extractor 209 processes and/or facilitates a processing of the context information, the user profile information, or a combination thereof to determine one or more keywords. The keywords may be stored in storage 217, in information spaces 113a-113m, in storage 119a-119i, or a combination thereof, for further access.

In one embodiment, per step 311 of FIG. 3, the visibility module 211 determines one or more user visibility settings associated with the context information, the user profile information, the one or more requests, or a combination thereof.

In one embodiment, per step 313 of FIG. 3, the request generator 203 processes and/or facilitating a processing of the context information, the user profile information, or a combination to cause, at least in part, a generation of one or more requests for advertising information. In one embodiment, the request may be based, at least in part, on the one or more keywords. In other embodiments, the one or more requests exposes identification information associated with the one or more user devices 107a-107i, the one or more users, or a combination thereof based, at least in part, on the one or more user visibility settings.

In one embodiment, per step 315 of FIG. 3, the context extractor 201 determines one or more computation closures, one or more functional flows of the one or more computation closures, or a combination thereof from the computation space 115a-115m, for collecting, processing, or a combination thereof of the context information, the user profile information, or a combination thereof.

In one embodiment, per step 317 of FIG. 3, the privacy module 215 causes, at least in part, a presentation of one or more privacy policies associated with the one or more computation closures, the one or more functional flows, or a combination thereof. The privacy policies may be retrieved from the information spaces 113a-113m, from the storages 119a-119i, from the storage 217 or a combination thereof. If privacy policies exist, per step 319 of FIG. 3, the privacy module 215 receives an input for selecting the one or more computation closures, the one or more functional flows, or a combination there based, at least in part, on the one or more privacy policies.

In one embodiment, per step 321 of FIG. 3, the transmission module 205 causes, at least in part, the transmission of the one or more requests to at least one advertising engine (not shown). The request may be transmitted to the one or more advertisement engines via one or more proxies. In one embodiment, the one or more proxies may apply the one or more user visibility settings to the one or more requests.

In one embodiment, per step 323 of FIG. 3, the visibility module 211 determines the one or more user visibility settings with respect to one or more individuals, one or more groups, or a combination thereof of the one or more user devices 107a-107i, the one or more users, or a combination thereof.

In one embodiment, per step 325 of FIG. 3, the presentation module 213 receives the advertising information from the advertisement engine in response to the one or more requests. The received advertisements may be stored in storage 217, in information spaces 113a-113m, on storage 119a-119i or a combination thereof.

In one embodiment, per step 327 of FIG. 3, the presentation module 213 causes, at least in part, a presentation of the advertising information at the one or more user devices 107a-107i via one or more user interfaces (UI) 109a-109i.

In one embodiment, per step 329 of FIG. 3, the presentation module 213 determines user interaction information associated with the advertising information, for example via providing advertisement rating options to the user such as thumbs up or down, recording user clicks on the advertisement, recording user's response to an offer or discount, etc.

In one embodiment, per step 331 of FIG. 3, the presentation module 213 causes, at least in part, a storage of the user interaction information in the one or more information sources 113a-113m, storage 217, storage 119a-119i or a combination thereof.

In one embodiment, per step 333 of FIG. 3, the presentation module 213 causes, at least in part, a generation of one or more subsequent requests, for example via the request generator 203, for advertising information based, at least in part, on the stored user interaction information.

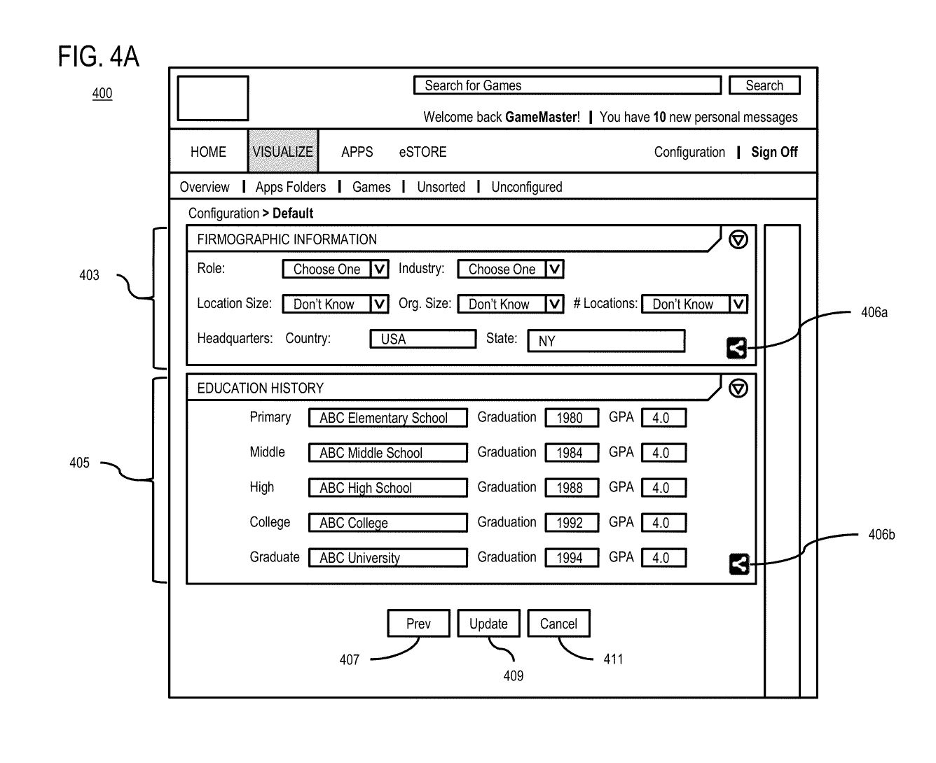

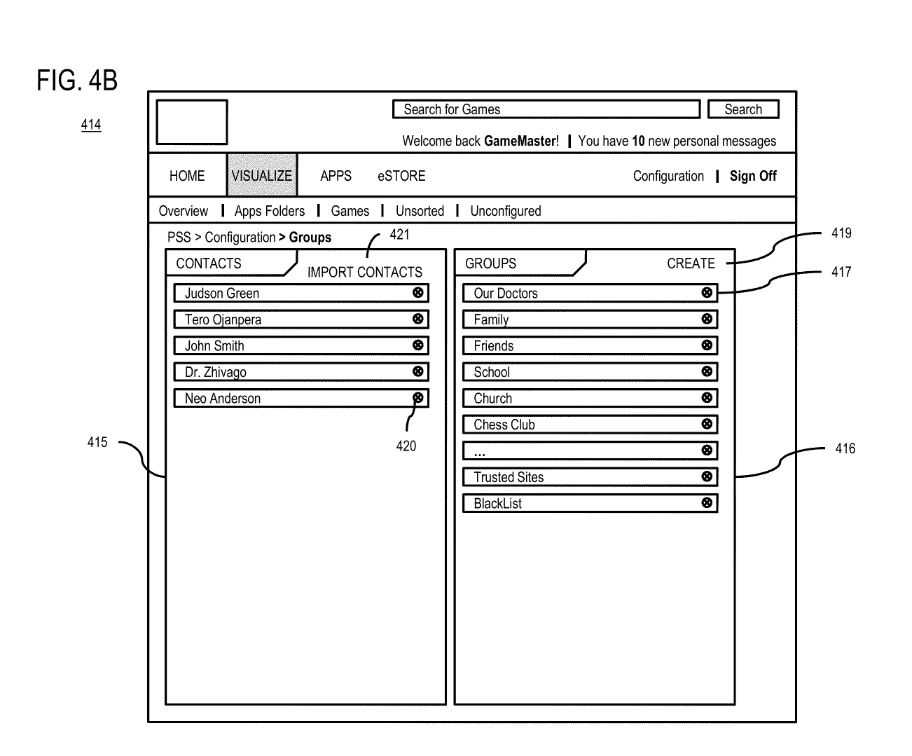

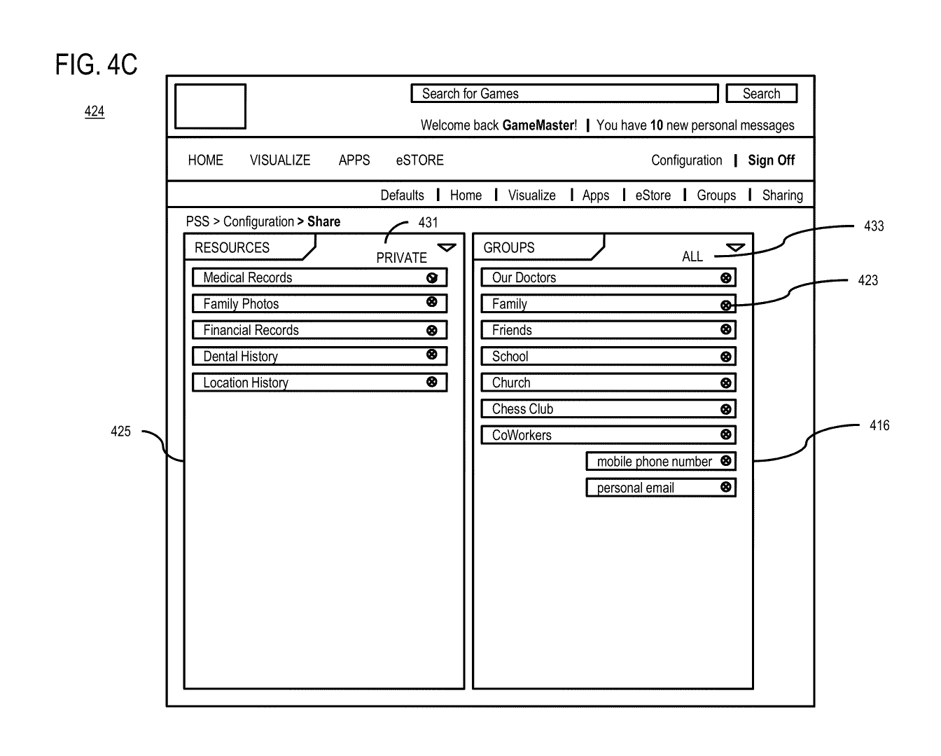

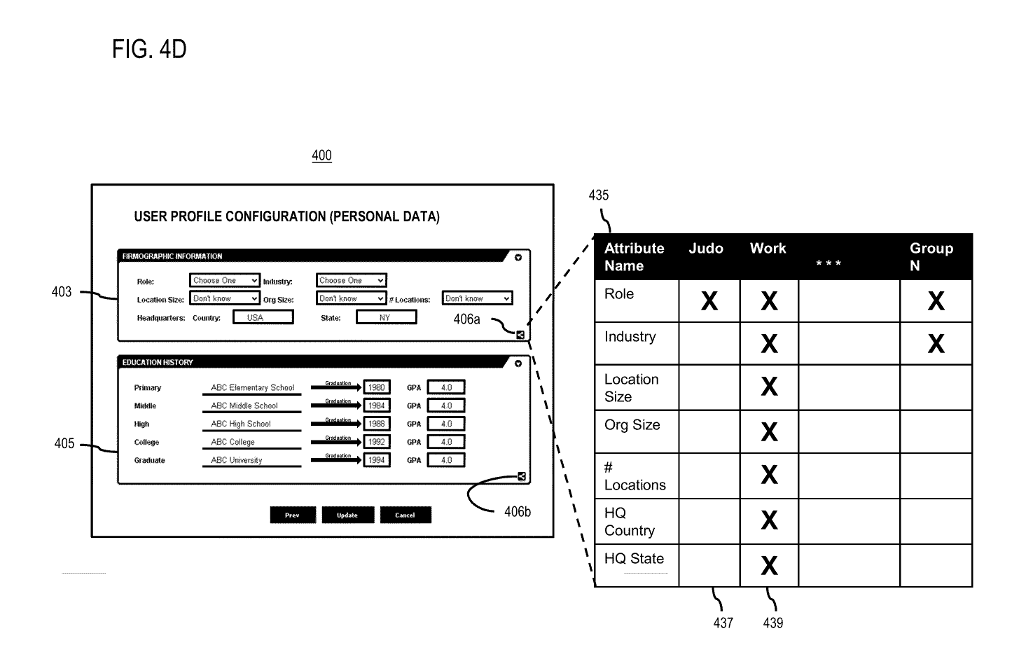

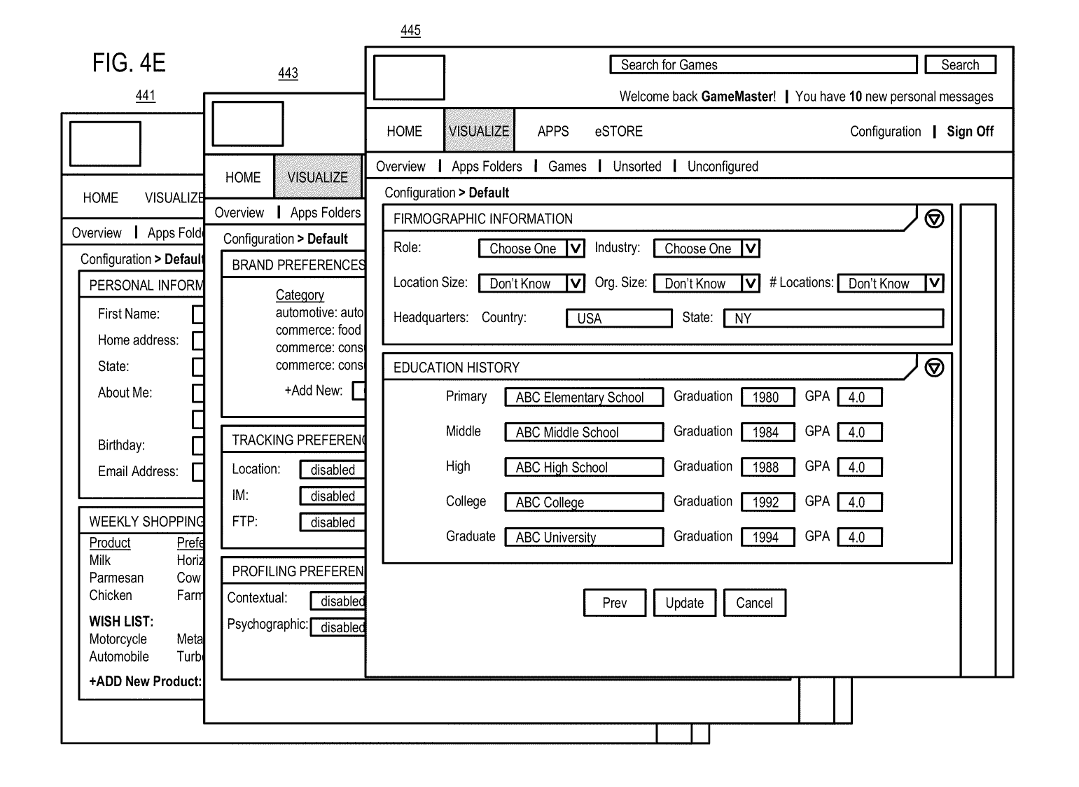

FIGS. 4A-4E are diagrams of user interfaces representing various functional flows for enabling the control and sharing of user profile information, according to various embodiments. By way of example, the functional flows correspond to the execution of one or more interface screens for enabling interaction between the user and the personalization platform 103. Particularly, the functional flows pertain to the various means by which a user is able to control the retrieval and/or collection of user profile information, context information, or a combination thereof within the information spaces 113a-113m. This includes the means for enabling the user to manage personal data, relationships with organizations, select which data to share and which data to conceal, control how data is used by others (e.g., advertisers) and for how long, and other functions. In certain embodiments, it is contemplated that the various interfaces may support the establishment or generation of a user profile information record and/or a personal profile stronghold for use over a cloud 111a-111n.

FIG. 4A presents an interface for enabling the configuration of personal data by way of manual entry, i.e., as a web-based form. The interface 400 on UI 109a-109i of UE 107a-107i features a firmographic information data entry section 403, which includes various fields for capturing information pertaining to the user's occupational or employer status. For example, the user may select one or more drop down menus to indicate a specific role, industry, location size, organization size, number of locations, and headquarters country and state information. Also, an education history data entry section 405 includes various fields for capturing information pertaining to the user's educational background. For example, the user may enter the names of the various schools attended from the Primary to Graduate level. Various other fields are also presented for receiving data regarding the year of graduation as well as the GPA of the user at the various stages of their education. Additionally, the configuration interface 400 features one or more data sharing control buttons 406a and 406b, which are associated with the firmographic information section 403 and education history section 405 respectively.

It is noted that the information can be updated (e.g., added or deleted) at the discretion of the user. In addition, one or more action buttons are featured for supporting user interaction, including a “PREV” action button 407 for reverting back to a prior instance of input at various of the fields, an “UPDATE” action button 409 for accepting any data input to the various fields and a “CANCEL” action button 411 for cancelling any data entry operations.

FIG. 4B presents an interface for enabling the configuration and management of group related data related to the user of UE 107a-107i. The interface 414 on UI 109a-109i of UE 107a-107i features a user defined group list section 416. Selection of a particular group also enables selection of an associated contact list 415 for displaying the various contacts associated with the group. By way of example, when the user selects the defined group entry “Our Doctors” 417 from the list 416, the user's martial arts class members are presented in the contacts section 415. The user can also add or delete entries to the lists 417 and 415, such as by selecting a “CREATE” link 419 or selecting a “DELETE” icon 420 respectively.

An “IMPORT CONTACTS” link 421 is also available for selection for enabling the user to import contacts from other sources via the information space. For example, contacts from an e-mail application, customer relationship management tool, online contact database or a social networking site may be imported and organized into one or more groups. Groups and contacts can also be merged and/or synchronized across applications. It is noted that the functional flow supports. The functional flow may also support drag and drop execution of contacts into one or more groups, i.e., by way of touch screen input. As mentioned previously, this input as received from the user may be the basis of one or more computations for affecting additional executions of the personalization platform 103.

FIG. 4C presents an interface for enabling the configuration and management of shared resources. The interface 424 on UI 109a-109i of UE 107a-107i features a user defined group list 416, along with a resources list 425 for indicating one or more resources associated with a select group entry. By way of example, when the user selects the user defined “Family” group entry 423, all resources associated for that group are listed in section 425. In the example, the resources include various categories for representing the storage of records, documents and photos. While not shown, user selection of a given resource entry results in a listing of the various records, documents and photos. Additional file types may also be maintained as resources, including audio, video and one or more executable applications e.g., a tax preparation application, etc.

A user may select a “PRIVATE” link 431 to filter the resource list 425 for display of only private resources. In addition, an “ALL” link 433 may be selected for displaying all groups within the group list 416. While not shown, selection of a particular group entry results in a listing of additional information regarding the group. This may include for example, a contact number, e-mail address, primary point of contact, etc. It is noted that drag and drop execution may be supported. Also, the user/consumer is able to customize data packages (for retrieval and/or collection of profile information) on the basis of time, geo-spatial extent, functional flow, specific attribute, etc.

FIG. 4D presents an interface for enabling the configuration of personal data control and updating. Reference is made again to interface 400 of FIG. 4A, which is shown by way of example in miniaturized form in FIG. 4D. When the user selects a data sharing control button 406a or 406b, a data view 435 for enabling user selection of one or more groups and/or contacts to be associated with specific elements of data is caused to be presented as part of the functional flow. By way of example, the data view 435 presents a matrix, featuring numerous columns and rows that represent various data elements (inputs) of the various configuration screens. Under the present scenario, the columns correspond to one or more user defined groups maintained in the group list 416 of FIG. 4B, i.e., Friends, Chess Club, etc. The rows that span across particular column corresponding to a particular attribute name or data entry field of the firmographic section 403. This includes a row for the role, industry, location size, etc.

A user may select or deselect a matrix entry in order to enable or disable the sharing of the corresponding attribute in the matrix with a particular group. For example, for the column 437 representing the Judo group designation, only the role attribute is selected for inclusion and sharing with contacts that fall into this group. For the column 439 representing the Work group designation, however, all of the attributes of the firmographic section 403 are selected for inclusion and sharing with the contacts that fall into this group. This feature may be executed at any point in the functional flow for affecting the sharing or un-sharing of specific information within the information space. It is noted also that this feature allows users to easily update their data setting features within context of the specific category of information to be impacted by the selection (or lack thereof).

As mentioned previously, the above described functional flows and corresponding response input provided by a user during execution of said flows dictates the means of data collection and/or level of access to data by respective interacting nodes within the information space. From the standpoint of a vendor related interaction, the user is able to indicate and control how they want to share their user profile information while still engaging with the vendor for specific reasons, e.g., to explore products, make purchases, etc.

FIG. 4E presents various visualizations of collected raw data by a user of UE 107a-107i. For example, interface 441, 443, and 445 on UI 109a-109i of UE 107a-107i may present profile data, log data, device data, etc. The presented data may include information such as personal information, weekly shopping list, brand preferences, tracking preferences, firmographic information, education history, etc.

In one embodiment, personal data can be packaged based on factors such as date interval, time interval, geospatial extent, a functional flow that generated the data, specific attributes of the data, speed, direction, etc., or a combination thereof. Furthermore, the users may create new packages based on their needs.

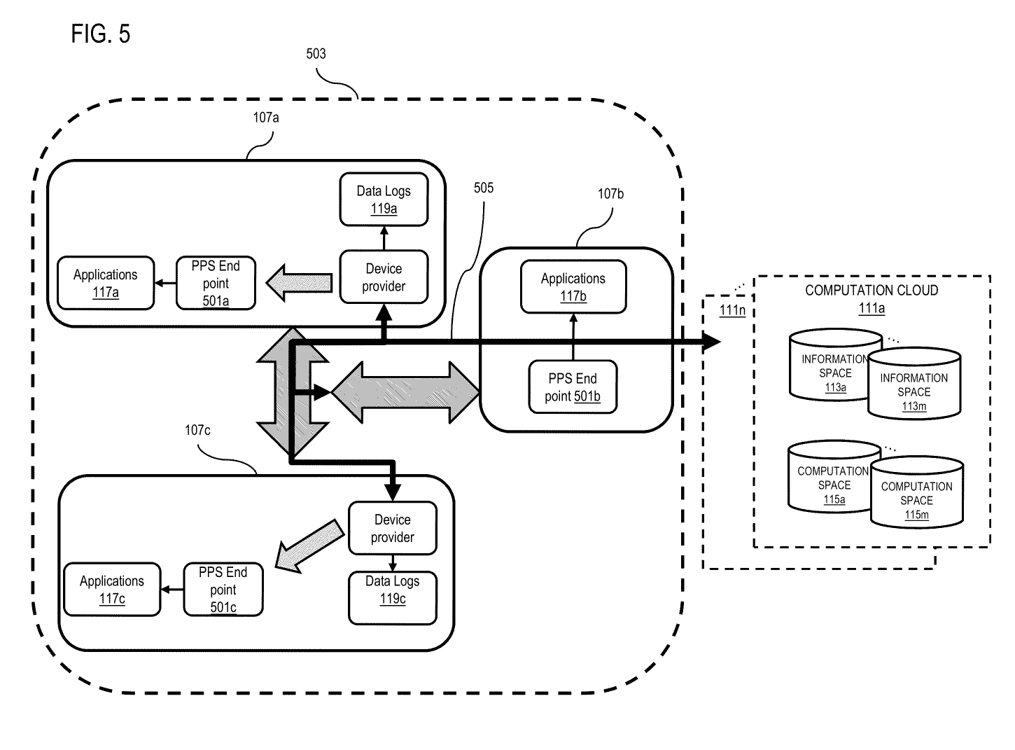

FIG. 5 is a diagram of a personal cloud, according to one embodiment. In one embodiment, users own and control all aspects of their own data via interfaces (as seen in FIGS. 4A-4E) presented on UI 109a-109i on UE 107a-107i, on their own user hosted personal cloud 503 composed on devices 107a-107i associated to the user.

In one embodiment, UEs 107a, 107b, and 107c belong to the same user and in combination provide a personal cloud 503 for the user. A UE 107a or 107c may include data logs 119a and 119c respectively, as part of their storage 119a, and 119c. In this embodiment, UE 107b does not include a data log. Furthermore, a UE 107a-107c may include a collection of applications 117a-117c which may include trusted application such as, for example, a personal advertisement controller application that functions in accordance with the personalization platform 103.

In one embodiment, each user has a personal profile stronghold (PPS) that can be accessed by the UE 107a, 107b, or 107c as a website via a URL, by a Uniform Resource Identifier (URI), or a combination thereof via PPS endpoints 501a, 501b, or 501c. The PPS allows the user to select their trusted applications to be included in applications 117a-117c, configure the trusted applications, visualize data collected by the trusted applications, etc.

In one embodiment, a user may set a default as to how they desire to be seen by advertisement targeting sites, third party tracking sites, etc. For example, a user may choose to be anonymous (completely invisible to the entities external to the personal cloud 503), pseudo anonymous (anonymous to any entities outside their current session), or fully disclosed (visible to all entities). An anonymous user will be seen as a different person by other entities with each web hit. However, a pseudo anonymous user will be seen as the same person within a session, but not between different sessions. For example, after closing a browser screen and starting a new session other entities are not able to recognize the user as the same user from previous session.

In one embodiment, the applications 117 may include a personal data collector application to collect data from communications between UEs 107a-107c, between UEs 107a-107c and cloud 111, or a combination thereof.

In one embodiment, each application 117 can access a data log 119, extract relevant information and write the extracted information into a storage (e.g. 119), an information space 113a-113m, or a combination thereof. Furthermore, the computations associated with personalization process and creation of personal cloud 503 can be decomposed into their elemental computation closures in computation spaces 115a-115m of clouds 111a-111n.

In one embodiment, the stored information on UEs 107a, 107b, and 107c are synchronized with each other and with computation clouds 111a-111n as shown by arrows 505. The synchronization enables the user to run their processes on clouds 111a-111n whenever resources on UEs 107a-107c are insufficient for the personal cloud 503 to perform the required processes.

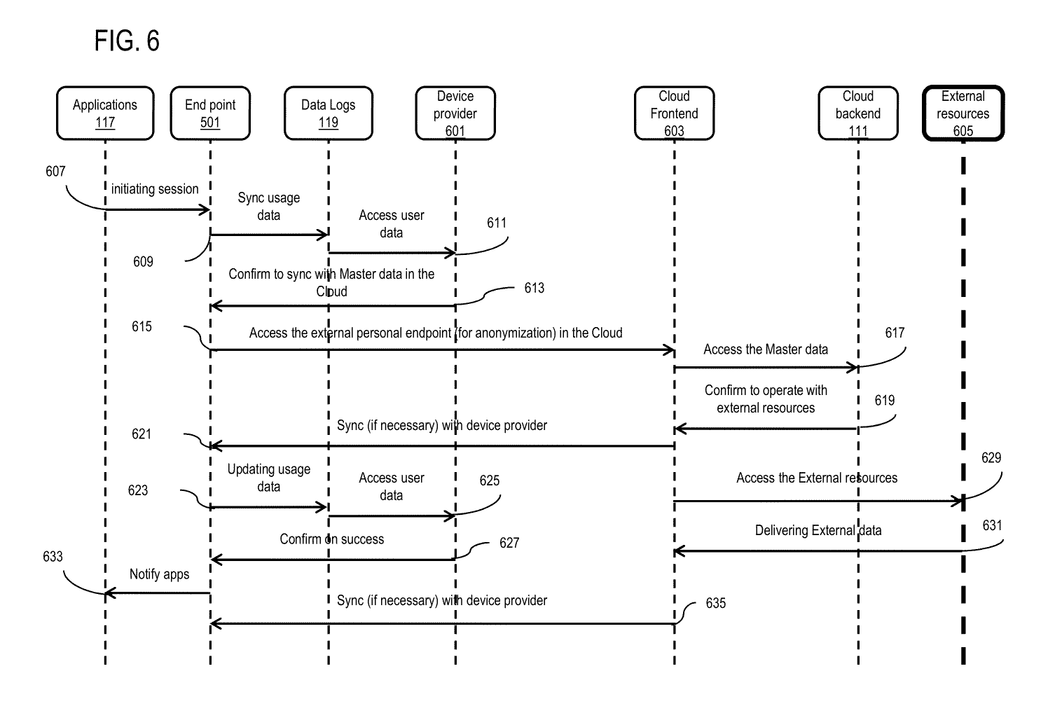

FIG. 6 is a diagram of anonymous personal usage tracking and synchronization in cloud, according to one embodiment. In one embodiment, per step 607 an application 117 sends a session initiation alert to a PPS endpoint 501. Per step 609, the PPS endpoint 501 initiates synchronization of usage data via data log 119. In step 611 the data log 119 accesses user data via a device provider 601. The device provider 601 initiates the data synchronization between the UE 107 (not shown) and a backend cloud 111. If the synchronization initiates successfully, the device provider 601 informs the endpoint 501 about the successful initialization of the synchronization, per step 613.

In one embodiment, per step 615 the endpoint 501 accesses an external endpoint (e.g., cloud frontend 603) in order to be anonymized in the cloud 111. Per step 617 the endpoint 501 accesses the information form cloud 111 as an anonymous entity. In return, the cloud 111 sends a confirmation of operation with external resources to the frontend 603.

In one embodiment, the cloud frontend 603 receives the confirmation from cloud 111, per step 619, and synchronizes the received information with UE 107, if necessary, via step 621. The endpoint 501 updates usage data in data logs 119 per step 623, based on the information received from cloud frontend 603.

In one embodiment, if the data is not found locally, per step 625 the data logs 119 accesses user data on device provider 601, per step 629 the cloud frontend 603 accesses external resources 605 and receives the external data per step 631.

In one embodiment, per step 627 the device provider 601 sends a confirmation of the successful data access (either locally or from external sources) to the endpoint 501. The endpoint 501 notifies the applications 117, per step 633, that the data has been delivered. And per step 635, the cloud frontend 603, once again synchronizes the received information with UE 107, if necessary.

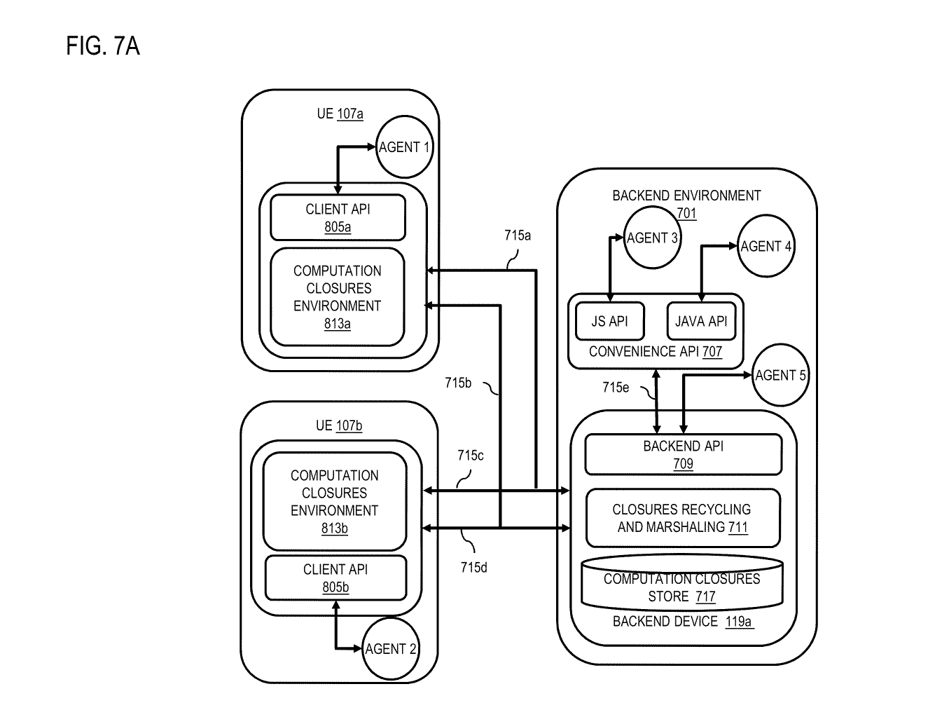

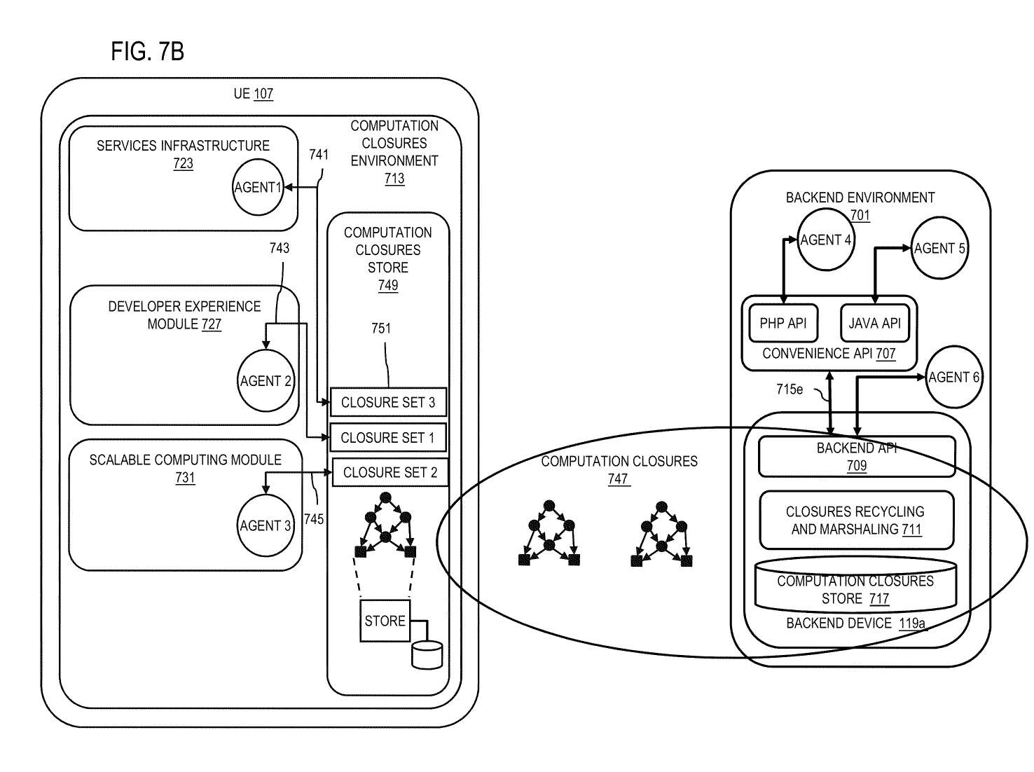

FIGS. 7A-7B are diagrams of computation distribution among devices, according to various embodiments. In one embodiment, in FIG. 7A, the backend environment 701 is a network infrastructure. The backend environment may also be a virtual run-time environment within a cloud 111 associated with the owner of UE 107a or on another UE 107b associated with the user. The backend environment 701 may include one or more components (backend devices) 701 and one or more Application Programming Interface (API) such as a convenience API 707 that may include APIs tailored to the software development environments used (e.g. JAVA, PHP, etc.). Furthermore, UEs 107a and 107b may include client APIs 705a and 705b. Each API enables interaction between devices and components within another device or an environment. For example, backend API 709 enables interaction between the backend device 701 and Agent5, and convenience API 707 enables interaction between the backend device 701 and agents Agent3 and Agent4, wherein each agent is a set of processes that handle computation closures within the backend environment 701. APIs 705a and 705b enable interaction between UE 107a and agent Agent1, and UE 107b and agent Agent2 respectively. As seen in the example of FIG. 7A, Agent3 works under PHP while Agent4 is a JAVA process. Each of the UEs 107a and 107b has a computation closure environment 713a and 713b which may be part of a cloud 111. Arrows 715a-715e represent distribution path of computation closures among the environments 713a, 713b and the computation closures store 717. The computation closures store 717 is a repository of computation closures that can be accessed and used by all the UEs and infrastructure components having connectivity to the backend environment 701.

In one embodiment, the backend device 701 may be equipped with a closure recycling and marshaling component 711 that monitors and manages any access to the computation closures store 717. In other embodiments the closure recycling and marshaling (i.e. standardization for uniform use) may be a function of the personalization platform 103.

In one embodiment, the computation closures within environments 713a, 713b and the computation closures store 717 may be composed based on anonymous function objects and automatically created by a compiling system using methods for generating anonymous function objects such as lambda expressions.

FIG. 7B is an expanded view of a computation closure environment 713 as introduced in FIG. 7A. The computation closure environment 713 may be composed of one or more computation closure generating components. In one embodiment the computation closure environment 713 has a services infrastructure 723 that provides various services for the user of the UE 107. The services may include any application that can be performed on the UE 107 such as, games, music, text messaging, voice calls, etc. In one embodiment, the services infrastructure 723 provides support for closure distribution under the supervision of a personalization platform 103 as discussed in FIG. 1, FIG. 2, and FIG. 3. The agent Agent1 retrieves the computation closures required by the services infrastructure 723 from the computation closures store 749 and stores the newly generated computation closures by the services infrastructure 723 into the computation closures store 749 for distribution purposes per arrow 741.

In another embodiment, the computation closure environment 713 has a developer experience module 727 that provides various tools for a developer for manipulating services offered by the UE 107. The tools may include standardized and/or abstract data types and services allowing the developers to chain processes together across development platforms. In one embodiment, the developer experience module 727 provides cross platform support for abstract data types and services under the supervision of a personalization platform 103 as discussed in FIG. 1. The agent Agent2 retrieves the computation closures required by the developer experience module 727 from the computation closures store 749 and stores the newly generated computation closures by the developer experience module 727 into the computation closures store 749 for distribution purposes per arrow 743.

In yet another embodiment, the computation closure environment 713 has a scalable computing module 731 that provides an abstract wrapper (i.e. monadic wrapper) for the transmitting closures 751. This abstraction provides computation compatibility between the closure sets 751 and the UE 107. The abstract wrapper may provide scheduling, memory management, system calls and other services for various processes associated with the closures 751. These services are provided under the supervision of the personalization platform 103 as discussed in FIG. 1. The agent Agent3 retrieves the computation closures required by the scalable computing module 731 from the computation closures store 749 and stores the newly generated computation closures by the scalable computing module 731 into the computation closures store 749 for distribution purposes per arrow 745. In one embodiment, the backend environment 701 may access the computation closures store 749 and exchange/transmit one or more computer closures 747 between the computation closures store 749 and the backend computation closures store 717.

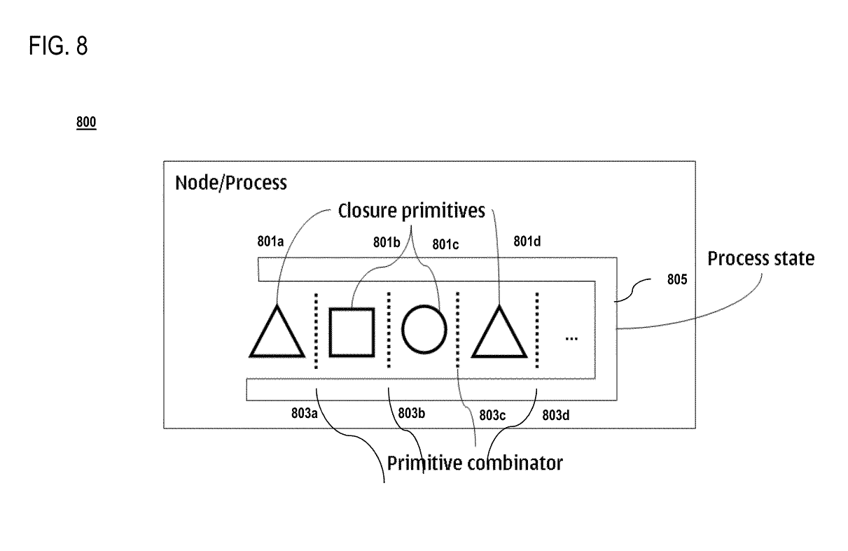

FIG. 8 is a diagram showing a process as a combination of primitive computation closures, according to one embodiment. Process 800 consists of closure primitives 801a-801d. The closure primitives 801a-801d, which are similar to geometric icon closures of FIG. 4, are combined with each other into process 800 by combinators 803a-803d. The object 805 represents the execution requirements including process states under which the execution of closures 801a-801d combined by combinators 803a-803d will result in the process 800.

In one embodiment, distribution of process 800 includes distribution of closures 801a-801d, combinators 803a-803d and the process states 805 as independent elements into, for instance, a backend environment 701. The independent closures 801a-801d from backend environment 701 may be distributed into different components of the backend environment 107 where they may be executed.

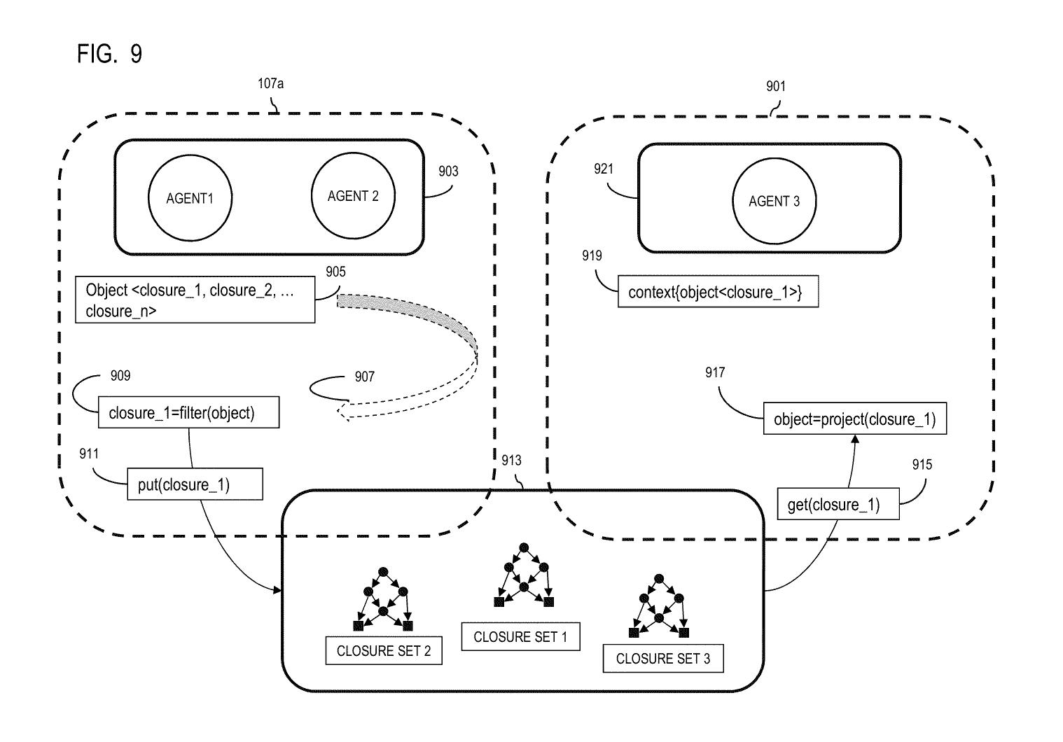

FIG. 9 is a diagram of process distribution from a device to another device, according to one embodiment. In one embodiment, the device 107a is a UE associated with the user. The UE 107a may include a user context 903 which is being transmitted among devices. Agent1 and agent2 are processors that calculate and handle computation closures within the user context 903. The number of agents may be different in different devices based on their design, functionality, processing power, etc. Block 905 represents an Object as a set of computation closures, closure_1, closure_2, . . . , and closure_n, where each closure is a component of a larger process, for example, related to a service provided to the user by the user equipment 107a. Each closure is a standalone process that can be executed independently from the other closures. In the example of FIG. 9, the filtering process 907 extracts closure_1 from the closure set Object via filtering the set (shown in block 909). The extracted closure_1 is added to a computation closure store 913 using the exemplary Put command 911.

It is assumed, in this example, that component 901 of a backend environment 701 is selected by the personalization platform 103 as a destination for closure distribution from UE 107a, based on the availability of sufficient security. The extracted computation closure, closure_1 is transmitted to component 901 following the assignment of a distribution path.

In one embodiment, the component 901 receives the computation closure closure_1 and extracts it from the computation closure store 913 using the Get command 915. The extracted closure_1 is projected into a closure with the user device context and the object 917 is produced. The block 919 represents the reconstruction of the closure into the initial context by a component in charge of the execution. The aggregated context may then be executed in the run-time environment 921 of component 901 by Agent3.

In another embodiment, the UE 107a and component 901 may exchange places and the distribution is performed from the component 901 to UE 107a or both devices may be UEs. In this embodiment the decomposition and aggregation processes are similar to the above example.

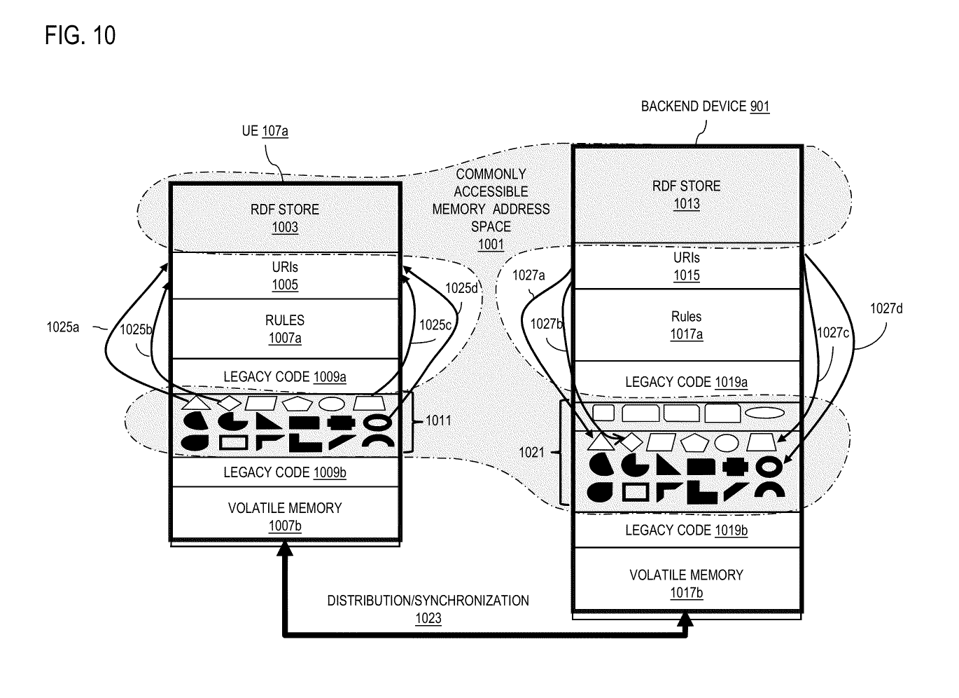

FIG. 10 is a diagram of computation closure allocation/mapping, according to one embodiment. The diagram of FIG. 10 shows a commonly accessible memory address space 1001 formed between a UE 107a as a client and the backend device 901 as a component of a computation infrastructure 117.

In one embodiment, the UE 107a may include RDF store 1003, which holds computation closures for processes associated with the UE 107a. Similarly the backend device 901 may includes a RDF store 1013, which holds computation closures associated with processes related to device 901, UEs 107a-107i, or any other devices having connectivity to device 901 or cloud 111.

In other embodiments, the Uniform Resource Identifiers (URIs) 1005 in UE 107a and 1015 in backend device 901 may be used to identify names or resources accessible to their respective devices via the communication network 105. Additionally, UE 107a and backend device 901 may have rule sets 1007a and 1017a that include security rules imposed on device similar to rules 569a-569b of FIG. 5B. It is noted that the rule base 1007a of UE 107a may be a subset of the rule base 1017a of the backend device 901, wherein the rules 1017a is a subset of a superset of rules managed by a cloud 111. Furthermore, the legacy codes associated with each device may be stored in legacy code memory areas 1009a and 1009b on UE 107a and 1019a and 1019b on backend device 901.

In one embodiment, UE 107a may be provided with a non-volatile memory space 1011 as a closure store. The closure store 1011 may include a set of closure primitives shown as geometric objects, similar to primitives of sets 751. Similarly, the backend device 901 may be provided with a non-volatile memory space 1021 as a closure store. The closure store 1021 may also include a set of closure primitives shown as geometric objects. In one embodiment, the closure store 1011 is a subset of closure store 1021 determined, at least in part, based on one or more criteria such as time of access, frequency of access, a priority classification, security settings, etc. The geometric shapes of closure stores 1011 and 1021 have been each divided into two groups of solidly filled geometric shapes (representing signed closures) and unfilled geometric shapes (representing unsigned closures). Since non-volatile memories are costly and require extensive resources (e.g. power consumption) compared with volatile memories (such as 1007a, 1007b, 1017a, and 1017b), the capacity of non-volatile memory on a UE 107a-107i is limited. However, a backend device 901, serving high numbers of users, may be equipped with larger volumes of non-volatile memory spaces. Because of the limited capacity of non-volatile memory spaces on UEs 107a-107i, and also because differing levels of security setup on various devices, only a subset of the closure store 1021 is stored locally at the closure store 1011 for local use by the UE 107a. In order to minimize the number of times a UE 107 needs to retrieve one or more primitives from closure store 1021 of device 109a, the subset 1011 is determined based on one or more criteria. In one embodiment, the closure store 1011 may be determined as a set of the most frequently accessed closure primitives of closure store 1021 by UE 107a. In another embodiment, the closure store 1011 may be determined as a set of the most recently accessed closure primitives of closure store 1021 by UE 107a. In other embodiments, various combined conditions and criteria may be used for determining subset 1011 from set 1021 as the content of closure store for UE 107a. Furthermore, the closure stores 1011 and 1021 may be periodically synchronized. The synchronization of closure stores ensures that any changes (addition, deletion, modification, etc.) in closure primitives and in root elements in closure store 1021 are reflected in the closure store 1011.

In one embodiment, for execution of a closure set 751 (a subset of closure store 1011) associated with a process on UE 107a, the set 751 can be transmitted under the supervision of the personalization platform 103 and after verification of the security of closures and capabilities of the destination component, to the backend device 901 which is a component of the infrastructure 117 (the distribution path shown as arrow 1023). The personalization platform 103 may then inform the processing components of the UE 107a, the backend device 901 or a combination thereof (the processing components are not shown), that the security of closure primitives has been approved and the closures are ready for execution. Alternatively, the personalization platform 103 may determine that the closures are not approved from point of view of the security and terminate their distribution and execution.

In one embodiment, any changes on the closure store 1021 of the backend device 901 (e.g., addition, deletion, modification, etc.) may first enter the URIs 1015 via the communication network 105. The changes may then be applied from URIs 1015 on closure store 1021 shown by arrows 1027a-1027d. Similarly, the closure store 1011 is updated based on the content of the closure store 1021 and the updates are shared with other authorized components within UE 107a (e.g. with URIs 1005 as shown by arrows 1025a-1025d).

The processes described herein for providing personalized advertisements may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

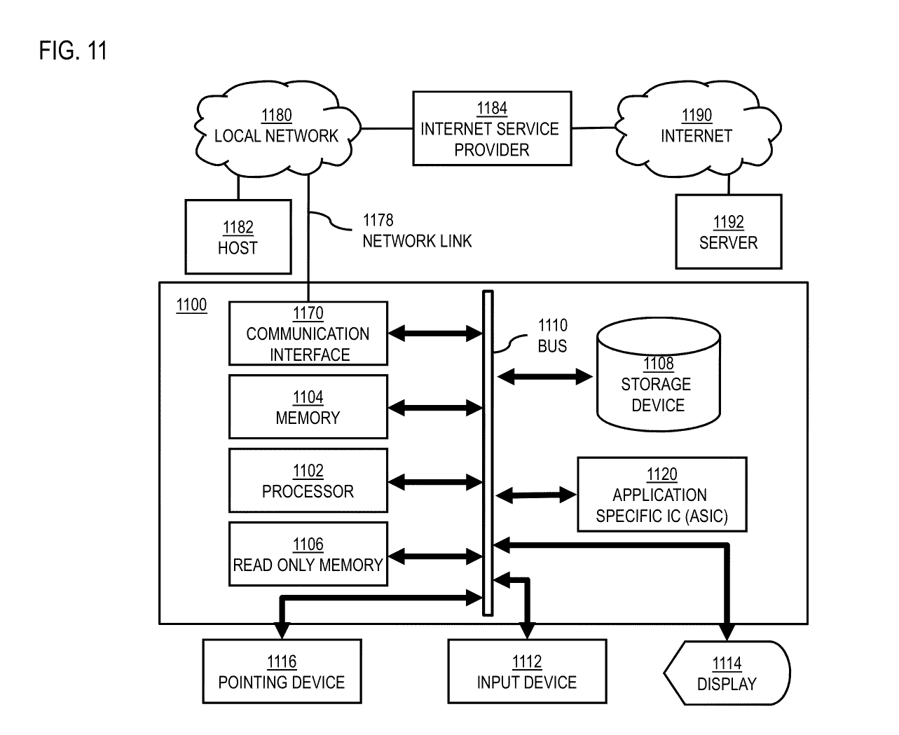

FIG. 11 illustrates a computer system 1100 upon which an embodiment of the invention may be implemented. Although computer system 1100 is depicted with respect to a particular device or equipment, it is contemplated that other devices or equipment (e.g., network elements, servers, etc.) within FIG. 11 can deploy the illustrated hardware and components of system 1100. Computer system 1100 is programmed (e.g., via computer program code or instructions) to provide personalized advertisements as described herein and includes a communication mechanism such as a bus 1110 for passing information between other internal and external components of the computer system 1100. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1100 or a portion thereof, constitutes a means for performing one or more steps of providing personalized advertisements.

A bus 1110 includes one or more parallel conductors of information so that information is transferred quickly among devices coupled to the bus 1110. One or more processors 1102 for processing information are coupled with the bus 1110.

A processor (or multiple processors) 1102 performs a set of operations on information as specified by computer program code related to providing personalized advertisements. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1110 and placing information on the bus 1110. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1102, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1100 also includes a memory 1104 coupled to bus 1110. The memory 1104, such as a random access memory (RAM) or any other dynamic storage device, stores information including processor instructions for providing personalized advertisements. Dynamic memory allows information stored therein to be changed by the computer system 1100. RAM allows a unit of information stored at a location called a memory address to be stored and retrieved independently of information at neighboring addresses. The memory 1104 is also used by the processor 1102 to store temporary values during execution of processor instructions. The computer system 1100 also includes a read only memory (ROM) 1106 or any other static storage device coupled to the bus 1110 for storing static information, including instructions, that is not changed by the computer system 1100. Some memory is composed of volatile storage that loses the information stored thereon when power is lost. Also coupled to bus 1110 is a non-volatile (persistent) storage device 1108, such as a magnetic disk, optical disk or flash card, for storing information, including instructions, that persists even when the computer system 1100 is turned off or otherwise loses power.

Information, including instructions for providing personalized advertisements, is provided to the bus 1110 for use by the processor from an external input device 1112, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1100. Other external devices coupled to bus 1110, used primarily for interacting with humans, include a display device 1114, such as a cathode ray tube (CRT), a liquid crystal display (LCD), a light emitting diode (LED) display, an organic LED (OLED) display, a plasma screen, or a printer for presenting text or images, and a pointing device 1116, such as a mouse, a trackball, cursor direction keys, or a motion sensor, for controlling a position of a small cursor image presented on the display 1114 and issuing commands associated with graphical elements presented on the display 1114. In some embodiments, for example, in embodiments in which the computer system 1100 performs all functions automatically without human input, one or more of external input device 1112, display device 1114 and pointing device 1116 is omitted.

In the illustrated embodiment, special purpose hardware, such as an application specific integrated circuit (ASIC) 1120, is coupled to bus 1110. The special purpose hardware is configured to perform operations not performed by processor 1102 quickly enough for special purposes. Examples of ASICs include graphics accelerator cards for generating images for display 1114, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1100 also includes one or more instances of a communications interface 1170 coupled to bus 1110. Communication interface 1170 provides a one-way or two-way communication coupling to a variety of external devices that operate with their own processors, such as printers, scanners and external disks. In general the coupling is with a network link 1178 that is connected to a local network 1180 to which a variety of external devices with their own processors are connected. For example, communication interface 1170 may be a parallel port or a serial port or a universal serial bus (USB) port on a personal computer. In some embodiments, communications interface 1170 is an integrated services digital network (ISDN) card or a digital subscriber line (DSL) card or a telephone modem that provides an information communication connection to a corresponding type of telephone line. In some embodiments, a communication interface 1170 is a cable modem that converts signals on bus 1110 into signals for a communication connection over a coaxial cable or into optical signals for a communication connection over a fiber optic cable. As another example, communications interface 1170 may be a local area network (LAN) card to provide a data communication connection to a compatible LAN, such as Ethernet. Wireless links may also be implemented. For wireless links, the communications interface 1170 sends or receives or both sends and receives electrical, acoustic or electromagnetic signals, including infrared and optical signals that carry information streams, such as digital data. For example, in wireless handheld devices, such as mobile telephones like cell phones, the communications interface 1170 includes a radio band electromagnetic transmitter and receiver called a radio transceiver. In certain embodiments, the communications interface 1170 enables connection to the communication network 105 for providing personalized advertisements to the UEs 107a-107i.

The term “computer-readable medium” as used herein refers to any medium that participates in providing information to processor 1102, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1108. Volatile media include, for example, dynamic memory 1104. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1120.

Network link 1178 typically provides information communication using transmission media through one or more networks to other devices that use or process the information. For example, network link 1178 may provide a connection through local network 1180 to a host computer 1182 or to equipment 1184 operated by an Internet Service Provider (ISP). ISP equipment 1184 in turn provides data communication services through the public, world-wide packet-switching communication network of networks now commonly referred to as the Internet 1190.

A computer called a server host 1192 connected to the Internet hosts a process that provides a service in response to information received over the Internet. For example, server host 1192 hosts a process that provides information representing video data for presentation at display 1114. It is contemplated that the components of system 1100 can be deployed in various configurations within other computer systems, e.g., host 1182 and server 1192.

At least some embodiments of the invention are related to the use of computer system 1100 for implementing some or all of the techniques described herein. According to one embodiment of the invention, those techniques are performed by computer system 1100 in response to processor 1102 executing one or more sequences of one or more processor instructions contained in memory 1104. Such instructions, also called computer instructions, software and program code, may be read into memory 1104 from another computer-readable medium such as storage device 1108 or network link 1178. Execution of the sequences of instructions contained in memory 1104 causes processor 1102 to perform one or more of the method steps described herein. In alternative embodiments, hardware, such as ASIC 1120, may be used in place of or in combination with software to implement the invention. Thus, embodiments of the invention are not limited to any specific combination of hardware and software, unless otherwise explicitly stated herein.

The signals transmitted over network link 1178 and other networks through communications interface 1170, carry information to and from computer system 1100. Computer system 1100 can send and receive information, including program code, through the networks 1180, 1190 among others, through network link 1178 and communications interface 1170. In an example using the Internet 1190, a server host 1192 transmits program code for a particular application, requested by a message sent from computer 1100, through Internet 1190, ISP equipment 1184, local network 1180 and communications interface 1170. The received code may be executed by processor 1102 as it is received, or may be stored in memory 1104 or in storage device 1108 or any other non-volatile storage for later execution, or both. In this manner, computer system 1100 may obtain application program code in the form of signals on a carrier wave.

Various forms of computer readable media may be involved in carrying one or more sequence of instructions or data or both to processor 1102 for execution. For example, instructions and data may initially be carried on a magnetic disk of a remote computer such as host 1182. The remote computer loads the instructions and data into its dynamic memory and sends the instructions and data over a telephone line using a modem. A modem local to the computer system 1100 receives the instructions and data on a telephone line and uses an infra-red transmitter to convert the instructions and data to a signal on an infra-red carrier wave serving as the network link 1178. An infrared detector serving as communications interface 1170 receives the instructions and data carried in the infrared signal and places information representing the instructions and data onto bus 1110. Bus 1110 carries the information to memory 1104 from which processor 1102 retrieves and executes the instructions using some of the data sent with the instructions. The instructions and data received in memory 1104 may optionally be stored on storage device 1108, either before or after execution by the processor 1102.

FIG. 12 illustrates a chip set or chip 1200 upon which an embodiment of the invention may be implemented. Chip set 1200 is programmed to provide personalized advertisements as described herein and includes, for instance, the processor and memory components described with respect to FIG. 11 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1200 can be implemented in a single chip. It is further contemplated that in certain embodiments the chip set or chip 1200 can be implemented as a single “system on a chip.” It is further contemplated that in certain embodiments a separate ASIC would not be used, for example, and that all relevant functions as disclosed herein would be performed by a processor or processors. Chip set or chip 1200, or a portion thereof, constitutes a means for performing one or more steps of providing user interface navigation information associated with the availability of functions. Chip set or chip 1200 or a portion thereof, constitutes a means for performing one or more steps of providing personalized advertisements.

In one embodiment, the chip set or chip 1200 includes a communication mechanism such as a bus 1201 for passing information among the components of the chip set 1200. A processor 1203 has connectivity to the bus 1201 to execute instructions and process information stored in, for example, a memory 1205. The processor 1203 may include one or more processing cores with each core configured to perform independently. A multi-core processor enables multiprocessing within a single physical package. Examples of a multi-core processor include two, four, eight, or greater numbers of processing cores. Alternatively or in addition, the processor 1203 may include one or more microprocessors configured in tandem via the bus 1201 to enable independent execution of instructions, pipelining, and multithreading. The processor 1203 may also be accompanied with one or more specialized components to perform certain processing functions and tasks such as one or more digital signal processors (DSP) 1207, or one or more application-specific integrated circuits (ASIC) 1209. A DSP 1207 typically is configured to process real-world signals (e.g., sound) in real time independently of the processor 1203. Similarly, an ASIC 1209 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1200 includes merely one or more processors and some software and/or firmware supporting and/or relating to and/or for the one or more processors.

The processor 1203 and accompanying components have connectivity to the memory 1205 via the bus 1201. The memory 1205 includes both dynamic memory (e.g., RAM, magnetic disk, writable optical disk, etc.) and static memory (e.g., ROM, CD-ROM, etc.) for storing executable instructions that when executed perform the inventive steps described herein to provide personalized advertisements. The memory 1205 also stores the data associated with or generated by the execution of the inventive steps.

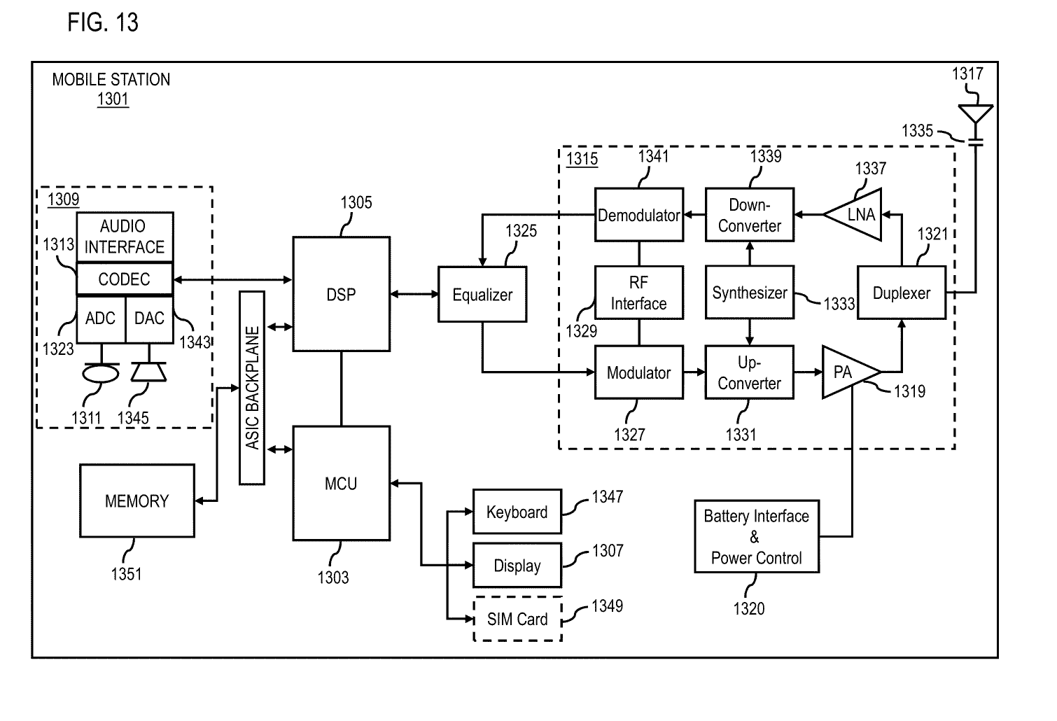

FIG. 13 is a diagram of exemplary components of a mobile terminal (e.g., handset) for communications, which is capable of operating in the system of FIG. 1, according to one embodiment. In some embodiments, mobile terminal 1301, or a portion thereof, constitutes a means for performing one or more steps of providing personalized advertisements. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1303, a Digital Signal Processor (DSP) 1305, and a receiver/transmitter unit including a microphone gain control unit and a speaker gain control unit. A main display unit 1307 provides a display to the user in support of various applications and mobile terminal functions that perform or support the steps of providing personalized advertisements. The display 1307 includes display circuitry configured to display at least a portion of a user interface of the mobile terminal (e.g., mobile telephone). Additionally, the display 1307 and display circuitry are configured to facilitate user control of at least some functions of the mobile terminal. An audio function circuitry 1309 includes a microphone 1311 and microphone amplifier that amplifies the speech signal output from the microphone 1311. The amplified speech signal output from the microphone 1311 is fed to a coder/decoder (CODEC) 1313.

A radio section 1315 amplifies power and converts frequency in order to communicate with a base station, which is included in a mobile communication system, via antenna 1317. The power amplifier (PA) 1319 and the transmitter/modulation circuitry are operationally responsive to the MCU 1303, with an output from the PA 1319 coupled to the duplexer 1321 or circulator or antenna switch, as known in the art. The PA 1319 also couples to a battery interface and power control unit 1320.

In use, a user of mobile terminal 1301 speaks into the microphone 1311 and his or her voice along with any detected background noise is converted into an analog voltage. The analog voltage is then converted into a digital signal through the Analog to Digital Converter (ADC) 1323. The control unit 1303 routes the digital signal into the DSP 1305 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1325 for compensation of any frequency-dependent impairment that occurs during transmission though the air such as phase and amplitude distortion. After equalizing the bit stream, the modulator 1327 combines the signal with a RF signal generated in the RF interface 1329. The modulator 1327 generates a sine wave by way of frequency or phase modulation. In order to prepare the signal for transmission, an up-converter 1331 combines the sine wave output from the modulator 1327 with another sine wave generated by a synthesizer 1333 to achieve the desired frequency of transmission. The signal is then sent through a PA 1319 to increase the signal to an appropriate power level. In practical systems, the PA 1319 acts as a variable gain amplifier whose gain is controlled by the DSP 1305 from information received from a network base station. The signal is then filtered within the duplexer 1321 and optionally sent to an antenna coupler 1335 to match impedances to provide maximum power transfer. Finally, the signal is transmitted via antenna 1317 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1301 are received via antenna 1317 and immediately amplified by a low noise amplifier (LNA) 1337. A down-converter 1339 lowers the carrier frequency while the demodulator 1341 strips away the RF leaving only a digital bit stream. The signal then goes through the equalizer 1325 and is processed by the DSP 1305. A Digital to Analog Converter (DAC) 1343 converts the signal and the resulting output is transmitted to the user through the speaker 1345, all under control of a Main Control Unit (MCU) 1303 which can be implemented as a Central Processing Unit (CPU).

The MCU 1303 receives various signals including input signals from the keyboard 1347. The keyboard 1347 and/or the MCU 1303 in combination with other user input components (e.g., the microphone 1311) comprise a user interface circuitry for managing user input. The MCU 1303 runs a user interface software to facilitate user control of at least some functions of the mobile terminal 1301 to provide personalized advertisements. The MCU 1303 also delivers a display command and a switch command to the display 1307 and to the speech output switching controller, respectively. Further, the MCU 1303 exchanges information with the DSP 1305 and can access an optionally incorporated SIM card 1349 and a memory 1351. In addition, the MCU 1303 executes various control functions required of the terminal. The DSP 1305 may, depending upon the implementation, perform any of a variety of conventional digital processing functions on the voice signals. Additionally, DSP 1305 determines the background noise level of the local environment from the signals detected by microphone 1311 and sets the gain of microphone 1311 to a level selected to compensate for the natural tendency of the user of the mobile terminal 1301.

The CODEC 1313 includes the ADC 1323 and DAC 1343. The memory 1351 stores various data including call incoming tone data and is capable of storing other data including music data received via, e.g., the global Internet. The software module could reside in RAM memory, flash memory, registers, or any other form of writable storage medium known in the art. The memory device 1351 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1349 carries, for instance, important information, such as the cellular phone number, the carrier supplying service, subscription details, and security information. The SIM card 1349 serves primarily to identify the mobile terminal 1301 on a radio network. The card 1349 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
at least one determination, at one or more user devices, of context information, user profile information, or a combination thereof from one or more information sources associated with one or more users of the one or more user devices, the one or more user devices, or a combination thereof;
a processing of the context information, the user profile information, or a combination to cause, at least in part, a generation of one or more requests for advertising information; and
a transmission of the one or more requests to at least one advertising engine.

2. A method of claim 1, wherein the (1) data and/or (2) information and/or (3) at least one signal are further based, at least in part, on the following:
one or more available information elements from the one or more information sources;
a presentation of the one or more available information elements at the one or more user devices; and
an input for selecting from among the one or more available information elements,
wherein the context information, the user profile information, or a combination thereof includes, at least in part, the selected available information elements.

3. A method of claim 2, wherein the one or more available information elements, the context information, the user profile information, or a combination thereof include, at least in part, advertisement targeting configuration information, demographic information, psychographic information, firmographic information, behavioral information, or a combination thereof.

4. A method of claim 1, wherein the (1) data and/or (2) information and/or (3) at least one signal are further based, at least in part, on the following:
a processing of the context information, the user profile information, or a combination thereof to determine one or more keywords,
wherein the generation of the one or more requests is based, at least in part, on the one or more keywords.

5. A method of claim 1, wherein the (1) data and/or (2) information and/or (3) at least one signal are further based, at least in part, on the following:
one or more user visibility settings associated with the context information, the user profile information, the one or more requests, or a combination thereof
wherein the one or more requests exposes identification information associated with the one or more user devices, the one or more users, or a combination thereof based, at least in part, on the one or more user visibility settings.

6. A method of claim 5, wherein the (1) data and/or (2) information and/or (3) at least one signal are further based, at least in part, on the following:
an initiation of the transmission of the one or more requests to the at least one advertising engine via one or more proxies,
wherein the one or more proxies apply the one or more user visibility settings to the one or more requests.

7. A method of claim 5, wherein the (1) data and/or (2) information and/or (3) at least one signal are further based, at least in part, on the following:
at least one determination of the one or more user visibility settings with respect to one or more individuals, one or more groups, or a combination thereof of the one or more user devices, the one or more users, or a combination thereof.

8. A method of claim 1, wherein the (1) data and/or (2) information and/or (3) at least one signal are further based, at least in part, on the following:
a receipt of the advertising information in response to the one or more requests;
a presentation of the advertising information at the one or more user devices;
user interaction information associated with the advertising information;
a storage of the user interaction information in the one or more information sources; and
a generation of one or more subsequent requests for the advertising information based, at least in part, on the user interaction information.

9. A method of claim 1, wherein the one or more information sources include, at least in part, one or more information spaces, the method further comprising:
one or more computation closures, one or more functional flows of the one or more computation closures, or a combination thereof for collecting, processing, or a combination thereof the context information, the user profile information, or a combination thereof.

10. A method of claim 9, wherein the (1) data and/or (2) information and/or (3) at least one signal are further based, at least in part, on the following:
a presentation of one or more privacy policies associated with the one or more computation closures, the one or more functional flows, or a combination thereof; and
receiving an input for selecting the one or more computation closures, the one or more functional flows, or a combination there based, at least in part, on the one or more privacy policies.

11. An apparatus comprising:
at least one processor; and
at least one memory including computer program code for one or more programs,
the at least one memory and the computer program code configured to, with the at least one processor, cause the apparatus to perform at least the following,
determine, at one or more user devices, context information, user profile information, or a combination thereof from one or more information sources associated with one or more users of the one or more user devices, the one or more user devices, or a combination thereof;
process and/or facilitate a processing of the context information, the user profile information, or a combination to cause, at least in part, a generation of one or more requests for advertising information; and
cause, at least in part, a transmission of the one or more requests to at least one advertising engine.

12. An apparatus of claim 11, wherein the apparatus is further caused to:
determine one or more available information elements from the one or more information sources;
cause, at least in part, a presentation of the one or more available information elements at the one or more user devices; and
receive an input for selecting from among the one or more available information elements,
wherein the context information, the user profile information, or a combination thereof includes, at least in part, the selected available information elements.

13. An apparatus of claim 12, wherein the one or more available information elements, the context information, the user profile information, or a combination thereof include, at least in part, advertisement targeting configuration information, demographic information, psychographic information, firmographic information, behavioral information, or a combination thereof.

14. An apparatus of claim 11, wherein the apparatus is further caused to:
process and/or facilitate a processing of the context information, the user profile information, or a combination thereof to determine one or more keywords,
wherein the generation of the one or more requests is based, at least in part, on the one or more keywords.

15. An apparatus of claim 11, wherein the apparatus is further caused to:
determine one or more user visibility settings associated with the context information, the user profile information, the one or more requests, or a combination thereof;
wherein the one or more requests exposes identification information associated with the one or more user devices, the one or more users, or a combination thereof based, at least in part, on the one or more user visibility settings.

16. An apparatus of claim 15, wherein the apparatus is further caused to:
cause, at least in part, the transmission of the one or more requests to the at least one advertising engine via one or more proxies,
wherein the one or more proxies apply the one or more user visibility settings to the one or more requests.

17. An apparatus of claim 15, wherein the apparatus is further caused to:
determine the one or more user visibility settings with respect to one or more individuals, one or more groups, or a combination thereof of the one or more user devices, the one or more users, or a combination thereof.

18. An apparatus of claim 11, wherein the apparatus is further caused to:
receive the advertising information in response to the one or more requests;
cause, at least in part, a presentation of the advertising information at the one or more user devices;
determine user interaction information associated with the advertising information;
cause, at least in part, a storage of the user interaction information in the one or more information sources; and
causing, at least in part, a generation of one or more subsequent requests for the advertising information based, at least in part, on the user interaction information.

19. An apparatus of claim 11, wherein the one or more information sources include, at least in part, one or more information spaces, the apparatus is further caused to:
determine one or more computation closures, one or more functional flows of the one or more computation closures, or a combination thereof for collecting, processing, or a combination thereof the context information, the user profile information, or a combination thereof.

20. An apparatus of claim 19, wherein the apparatus is further caused to:
cause, at least in part, a presentation of one or more privacy policies associated with the one or more computation closures, the one or more functional flows, or a combination thereof; and
receive an input for selecting the one or more computation closures, the one or more functional flows, or a combination there based, at least in part, on the one or more privacy policies.
